(19) United States
(12) Patent Application Publication
(10) Pub. No.: US 2005/0111698 A1
(43) Pub. Date: May 26, 2005

(54) Apparatus for vehicle surroundings monitoring and method thereof

(75) Inventor: Akio Kawai, Yamato-shi (JP)

Correspondence Address: MCDERMOTT WILL & EMERY LLP, 600 13TH STREET, N.W., WASHINGTON, DC, 20005-3096, US

(73) Assignee: NISSAN MOTOR CO., LTD.

(21) Appl. No.: 10/988,531

(22) Filed: Nov. 16, 2004

(30) Foreign Application Priority Data
Nov. 20, 2003 (JP) P2003-390369

(51) Int. Cl. G06K 9/00

(52) U.S. Cl. 382/103; 348/143; 348/135; 382/190; 382/209; 340/435

(57) ABSTRACT

An aspect of the present invention provides a vehicle surroundings monitoring device that includes an object extracting unit configured to extract objects that emit infrared rays from a photographed infrared image, a pedestrian candidate extracting unit configured to extract pedestrian candidates based on the shape of the images of objects extracted by the object extracting unit, and a structure exclusion processing unit configured to exclude structures from the pedestrian candidates based on the gray levels of the images of the pedestrian candidates.

### BACKGROUND OF THE INVENTION

The present invention relates to a vehicle surroundings monitoring device configured to detect pedestrians existing in the vicinity of the vehicle.

Japanese Laid-Open Patent Publication No. 2001-6069 discloses vehicle surroundings monitoring device configured to detect a pedestrian existing in the vicinity of the vehicle using an infrared image photographed with a photographing means provided on the vehicle. The vehicle surroundings monitoring device described in that publication calculates the distance between the vehicle and an object located in the vicinity of the vehicle using images obtained from two infrared cameras and calculates the motion vector of the object based on position data found using a time series. Then, based on the direction in which the vehicle is traveling and the motion vector of the object, the device detects if there is a strong possibility of the vehicle colliding with the object.

Japanese Laid-Open Patent Publication No. 2001-108758 discloses a technology that uses an infrared image photographed with a photographing means provided on the vehicle to detect objects existing in the vicinity of the vehicle while excluding regions exhibiting temperatures that are clearly different from the body temperature of a pedestrian. If an object is extract from the portions that remain after excluding regions exhibiting temperatures that are clearly different from the body temperature of a pedestrian, the ratio of the vertical and horizontal dimensions of the object are checked in order to determine if the object is a pedestrian.

Japanese Laid-Open Patent Publication No. 2003-16429 discloses a technology whereby objects emitting infrared rays are extracted from an infrared image photographed with a camera device. The images of the extracted objects are compared to reference images that serve as elements of identifying structures and it is determined if each object is a structure. Objects determined to be structures are then excluded and the remaining objects are detected as being a pedestrian, animal, or moving object.

### SUMMARY OF THE INVENTION

Although the technologies disclosed in Japanese Laid-Open Patent Publication No. 2001-6069 and Japanese Laid-Open Patent Publication No. 2001-108758 are capable of detecting objects that emit infrared rays, these technologies have suffered from the problem of detecting objects other than pedestrians. For example, they detect such objects as vending machines and other objects that emit heat independently, such objects as telephone poles and light posts that have been heated by the sun during the day, and other objects that are of little importance with regard to the operation of the vehicle. More particularly, these technologies are unable to distinguish between a pedestrian and an object having a similar vertical dimension to that of a pedestrian and a temperature similar to the body temperature of a pedestrian. Furthermore, when an attempt is made to extract pedestrians from among the detected objects by merely employing such a shape identification method as checking the ratio of the vertical dimension to the horizontal dimension, it is difficult to improve the degree of accuracy.

Meanwhile, the technology disclosed in Japanese Laid-Open Patent Publication No. 2003-16429 uses prescribed templates to determine if an object is a structure by executing template matching processing. Stereo infrared cameras are necessary to perform the distance measurements for setting the template and, consequently, the device becomes very expensive. Furthermore, the template matching processing creates a heavy computer processing load and it becomes necessary to use a high-speed CPU (central processing unit) and a special DSP (digital signal processor), again causing the device to be expensive. Additionally, since it is not possible to prepare templates that cover all of the possible patterns of structures that actually exist, structures that do not match any of the templates used for comparison with extracted objects are recognized as pedestrians, thus causing the degree of accuracy with which pedestrians are detected to be low.

The present invention was conceived in view of these problems and its object is to provide a vehicle surroundings monitoring device that detects pedestrians with a high degree of accuracy and is low in cost.

An aspect of the present invention provides a vehicle surroundings monitoring device that includes an object extracting unit configured to extract objects that emit infrared rays from a photographed infrared image, a pedestrian candidate extracting unit configured to extract pedestrian candidates based on the shape of the images of objects extracted by the object extracting unit, and a structure exclusion processing unit configured to exclude structures from the pedestrian candidates based on the gray levels of the images of the pedestrian candidates.

Another aspect of the present invention provides a vehicle surroundings monitoring method that includes, emitting infrared rays from a vehicle, receiving infrared rays reflected from objects existing in the vicinity of the vehicle and creating an infrared image, extracting from the infrared image those objects that reflect a quantity of infrared rays equal to or exceeding a prescribed quantity, extracting the images of pedestrian candidates based on the shapes of the images of the extracted objects, determining if the pedestrian candidates are structures based on the gray levels of the images of the pedestrian candidates, and determining that the pedestrian candidates that have not been determined to be structures are pedestrians.

### BRIEF DESCRIPTION OF DRAWINGS

FIG. 1 is a block diagram showing an embodiment of a vehicle surroundings monitoring device in accordance with the present invention.

FIG. 2 is a diagrammatic view for explaining the positional relationship between the vehicle surroundings monitoring device and detected objects.

FIG. 3 is a flowchart showing the processing steps executed by the vehicle surroundings monitoring device 101.

FIG. 4A shows an original image photographed by the infrared camera 102 and FIG. 4B serves to explain the bright region extraction image for a case in which, for example, a pedestrian P1, a sign B1, and traffic signs B2 and B3 exist in front of the vehicle as shown in FIG. 2.

FIG. 5 is a diagrammatic view illustrating the bright regions recognized as pedestrian candidate regions.

FIG. 6 is a diagrammatic view illustrating the pedestrian candidate region that remains after the pedestrian candidate regions determined to be structures by the structure exclusion processing have been excluded.

FIG. 7 shows the photographed image with the pedestrian region emphasized. In step S111, the image processing unit 112 outputs the original image with the frame added thereto to the HUD unit 104.

FIG. 8 is a flowchart for explaining the processing used to extract the pedestrian candidate regions from among the extracted bright regions.

FIGS. 9A, 9B, and 9C are diagrammatic views for explaining the method of determining if a bright region is a pedestrian candidate region based on the vertical to horizontal dimension ratio of the bright region.

FIG. 10 is a flowchart for explaining another processing used to extract the pedestrian candidate regions from among the extracted bright regions.

FIG. 11A is a gray level histogram illustrating a typical pixel gray level distribution in the case of a traffic sign or other road sign, and FIG. 11B is a gray level histogram illustrating a typical pixel gray level distribution in the case of a pedestrian.

FIG. 12 is a flowchart for explaining another processing used to extract the pedestrian candidate regions from among the extracted bright regions.

### DETAILED DESCRIPTION OF THE EMBODIMENTS

Various embodiments of the present invention will be described with reference to the accompanying drawings. It is to be noted that same or similar reference numerals are applied to the same or similar parts and elements throughout the drawings, and the description of the same or similar parts and elements will be omitted or simplified.

### Embodiment 1

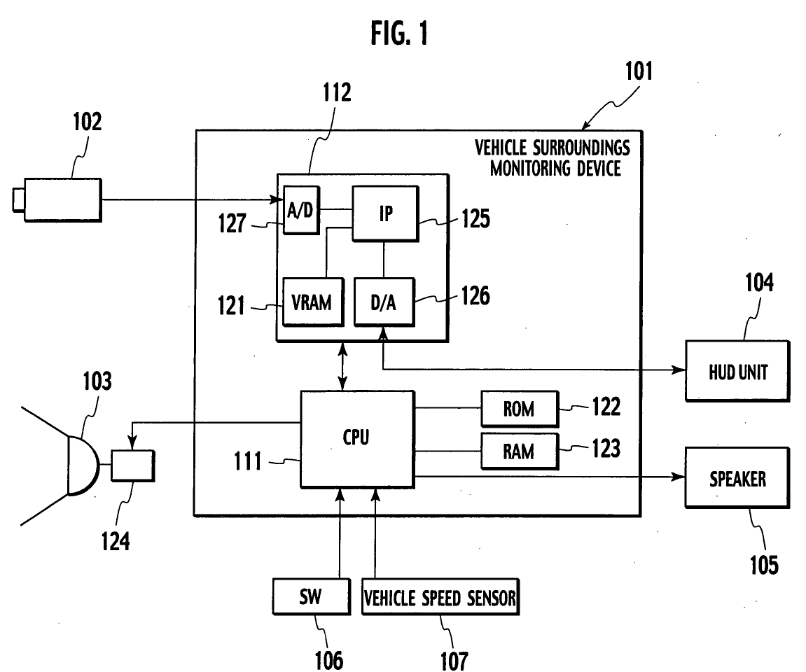

FIG. 1 is a block diagram showing an embodiment of a vehicle surroundings monitoring device in accordance with the present invention. The vehicle surroundings monitoring device provided with a CPU 111 and an image processing unit 112 and is electrically coupled to the following: a switch relay 124 for a floodlight 103 configured to illuminate a prescribed region range in front of the vehicle with light having a near-infrared wavelength; an infrared camera 102 capable of detecting near infrared light; a switch (SW) 106 configured to turn the function of the vehicle surroundings monitoring device 101 on and off; and a vehicle speed sensor 107 configured to detect the traveling speed of the vehicle in which the vehicle surroundings monitoring device 101 is installed (hereinafter called “vehicle speed”).

The vehicle surroundings monitoring device 101 is also electrically coupled to a speaker 105 for emitting alarm sounds and a head-up display unit (hereinafter called “HUD unit”) 104 configured to display the image photographed by the infrared camera 102 and display information calling the vehicle driver's attention to objects having a high risk of collision on, for example, a prescribed position of the windshield where the driver can see the information without moving his or her line of sight.

The constituent features of the device will now be described in detail. The image processing unit 112 of the vehicle surroundings monitoring device 101 has an A/D converter circuit 127 configured to convert the analog input signal from the infrared camera 102 into a digital signal, an image processor 125, an image memory (hereinafter called “WRAM”) 121 configured to store digitized image signals, and a D/A converter circuit 126 configured to return the digital image data to an analog image signal. The image processing unit 112 is connected to the CPU 111 and the HUD unit 104.

The CPU 111 executes various computer processing and controls the vehicle surrounding monitoring device as a whole. The CPU 111 is connected to a read only memory (ROM) 122 for storing setting values and executable programs and a random access memory (RAM) 123 for storing data during processing operations. The CPU 111 is also configured to send voice signals to the speaker 105 and ON/OFF signals to the switch relay 124 and to receive ON/OFF signals from the switch 106 and the vehicle speed signal from the vehicle speed sensor 107.

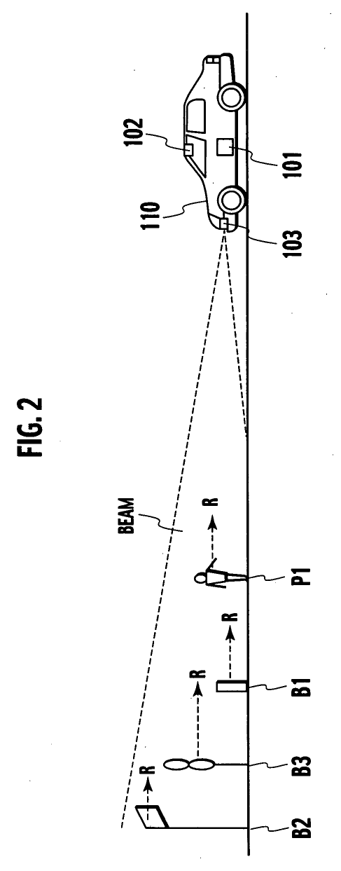

FIG. 2 is a diagrammatic view for explaining the positional relationship between the vehicle surroundings monitoring device and detected objects. The infrared camera 102 is provided to a front portion of the vehicle 110 along the longitudinal centerline of the vehicle such that its optical axis is oriented in the forward direction of the vehicle. Floodlights 103 are provided on the left and right of the front bumper section. The floodlights 103 are turned on when the switch relay 124 is ON and serve to provide near-infrared illumination in the forward direction.

The output characteristic of the infrared camera 102 is such that the output signal level is higher (brightness is higher) at portions of the image where more near-infrared radiation is reflected from an object and lower at portions of the image where less near-infrared radiation is reflected from an object. A pedestrian P1, a vertically long sign B1, a horizontally long rectangular traffic sign B2, and a series of vertically arranged round traffic signs B3 are illuminated by the near-infrared beams emitted by the floodlights 103. Each of these items reflects the near-infrared light as indicated by the broken-line arrows and the reflected light R is captured by the infrared camera 102 as an image having a gray level equal to or above a threshold value.

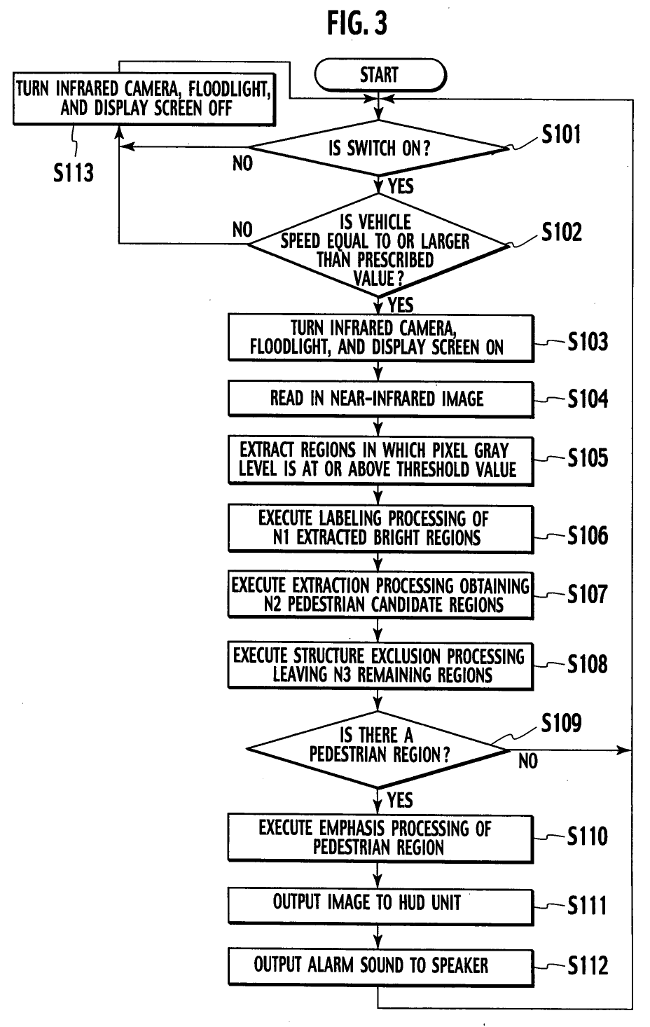

FIG. 3 is a flowchart showing the processing steps executed by the vehicle surroundings monitoring device 101. The processing shown in the flowchart is accomplished by means of programs executed the CPU 111 and the image processor 125 of the image processing unit 112. When the ignition switch of the vehicle 110 is turned on, the vehicle surroundings monitoring device starts up. In step S101, the CPU 111 enters a waiting state from which it checks if the switch 106 of the vehicle surroundings monitoring device 101 is ON. The CPU 111 proceeds to step S102 if the switch 106 is ON and step S113 if the switch 106 is OFF. In step S102, the CPU 111 checks the vehicle speed detected by the vehicle speed sensor 107 and determines if the vehicle speed is equal to or above a prescribed value. In this embodiment, the prescribed vehicle speed is 30 km/h, for example. If the vehicle speed equal to or above 30 km/h the CPU 111 proceeds to step S103. If the vehicle speed is less than 30 km/h, the CPU 111 proceeds to step S113, where it turns the infrared camera 102, the floodlights 103, and the HUD unit 104 off (if they were on) and returns to step S101.

The reason for returning to step S101 when the vehicle speed is below the prescribed vehicle speed is that it is not necessary to direct caution toward obstacles located at long distances in front of the vehicle when the vehicle is traveling at a low speed and obstacles located at medium distances can be detected visually by the driver. Therefore, the floodlights 103 are turned off to prevent the unnecessary power consumption that would result from the near-infrared illumination of distant objects. The invention is not limited, however, to operation at vehicle speeds of 30 km/h and above and it is also acceptable to configure the device such that any desired vehicle speed can be selected.

In step S103, the CPU 111 turns the infrared camera 102, the floodlights 103, and the HUD unit 104 on (if they were off). The infrared camera 102 obtains a brightness image, i.e., a gray level image, whose brightness varies in accordance with the intensity of the light reflected from objects illuminated by the floodlights 103. In the following explanations, this image is called the “original image.”

FIG. 4A shows an original image photographed by the infrared camera 102 and FIG. 4B serves to explain the bright region extraction image for a case in which, for example, a pedestrian P1, a sign B1, and traffic signs B2 and B3 exist in front of the vehicle as shown in FIG. 2. In the original image shown in FIG. 4A, the pedestrian P1, sign B1, traffic sign B2, and traffic sign B3 are pictured in order from left to right. In step S104, the image processing unit 112 reads the image from the infrared camera 102, converts original image into a digital image with the A/D converter, and stores the digitized original image in the VRAM 121. This embodiment presents a case in which the gray level of each pixel is expressed in an 8-bit manner, i.e. using grayscale having 256 different gray levels, where 0 is the darkest value and 256 is the brightest value. However, the invention is not limited to such a grayscale arrangement.

In step S105, the image processing unit 112 substitutes 0 for the gray level of pixels whose gray level in the original image is less than a threshold value and maintains the gray level of pixels whose gray level in the original image is equal to or above the threshold value, thereby obtaining a bright region extraction image like that shown in FIG. 4B. The image processing unit 112 then stores the bright region extraction image in the VRAM 121. As a result of this processing, a region A5 of the road surface immediately in front of the vehicle where the near-infrared fight of the floodlights 103 strikes strongly and bright regions A1, A2, A3, and A4 corresponding to the pedestrian P1, sign B1, traffic sign B2, and traffic sign B3 (from left to right in the original image) are extracted. Methods of setting the threshold value used to extract objects from the original image include setting the threshold value to a gray level corresponding to a valley in the gray level distribution based on a gray level histogram of the original image and setting the threshold value to a fixed value obtained experimentally. In this embodiment, the threshold value is a fixed gray level value of 150, which is a threshold value that enables objects that reflect a certain degree of near-infrared light to be extracted at night based on the nighttime near-infrared image characteristics. However, the threshold value should be set as appropriate in accordance with the output characteristic of the floodlights 103 used to provide the near-infrared illumination and the sensitivity characteristic of the infrared camera 103 with respect to near-infrared light and the invention is not limited to a threshold value of 150.

In step S106, the image processing unit 112 reads the bright region extraction image stored in the VRAM 121 in step S105 and outputs information describing each individual bright region to the CPU 111. The CPU 111 then executes labeling processing to assign a label to each of the bright regions. The number of extracted regions that are labeled is indicated as N1. In this example, N1=5.

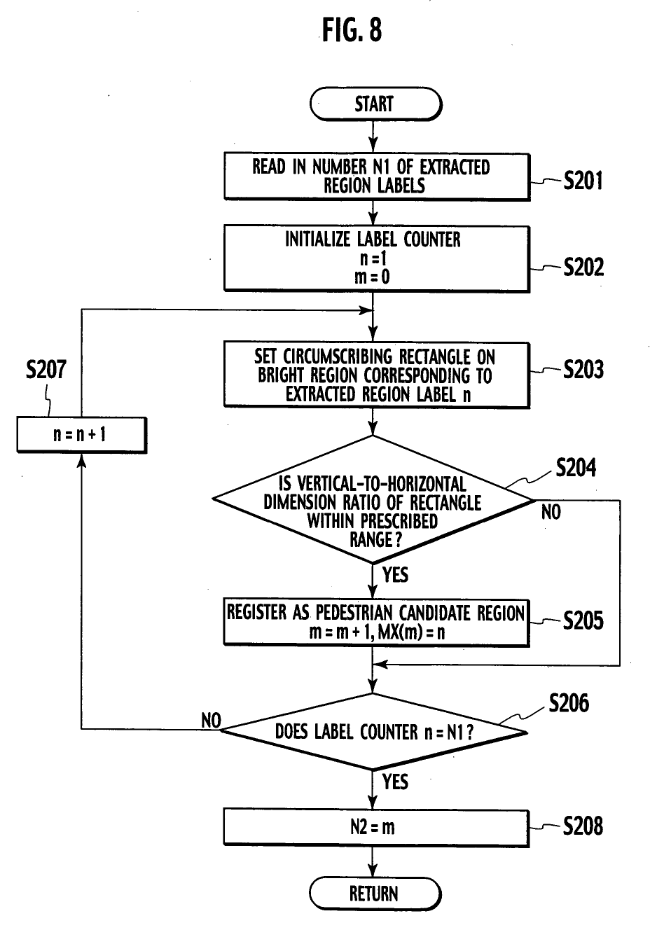

In step 107, the image processing unit 112 executes extraction processing to extract pedestrian candidate regions from among the bright regions. The processing of this step is shown in the flowchart of FIG. 8. The number N2 of regions extracted by this pedestrian candidate region extraction processing is stored in the RAM 123.

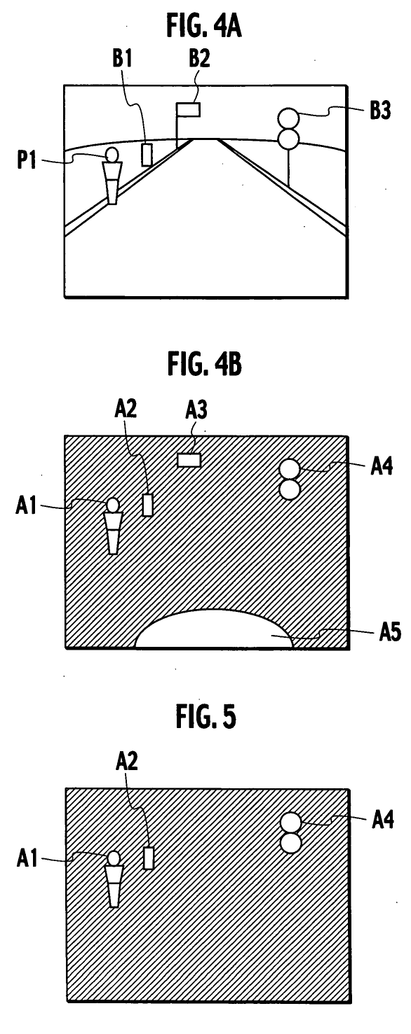

FIG. 5 is a diagrammatic view illustrating the bright regions recognized as pedestrian candidate regions. If the pixels were temporarily set to a gray level of 0 in the bright regions of the bright region extraction image shown in FIG. 4B that have been determined not to be pedestrian candidate regions, the image that remained would be the pedestrian candidate extraction image shown in FIG. 5. The pedestrian candidate extraction image contains only those bright regions having a vertical dimension to horizontal dimension ratio within a prescribed range.

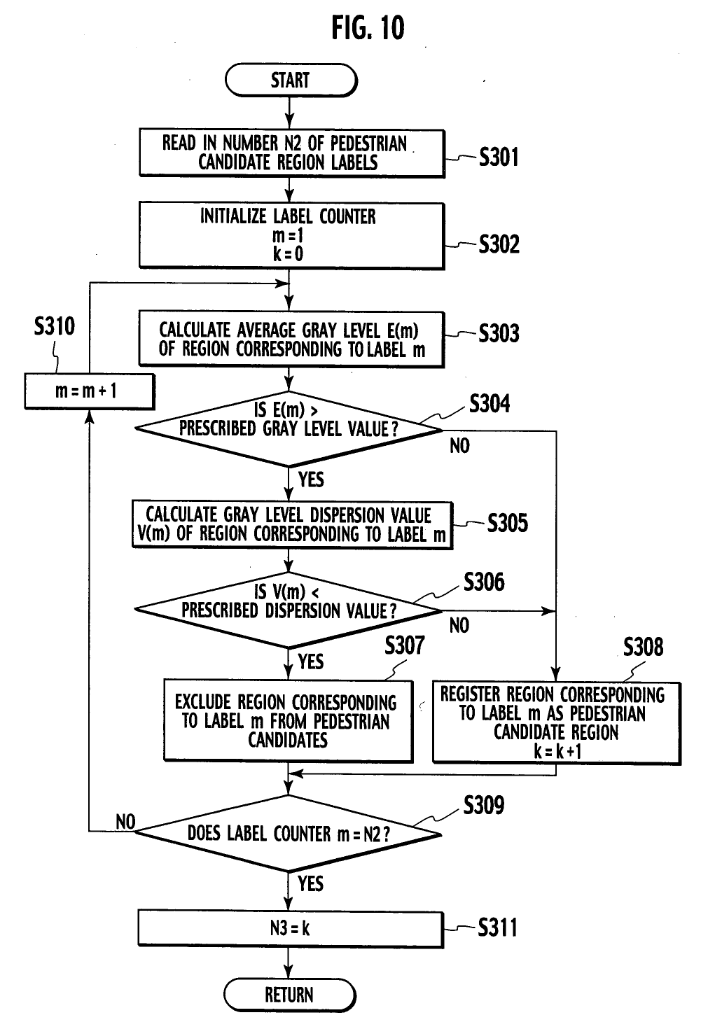

In step 108, the image processing unit 112 executes structure exclusion processing with respect to the brightness region extraction image stored in the VRAM 121 in step S105 to determine if each of the N2 pedestrian candidate regions is an object that is not a pedestrian (such objects hereinafter called “structures”). The details of the structure exclusion processing are discussed later with reference to the flowchart of FIG. 10.

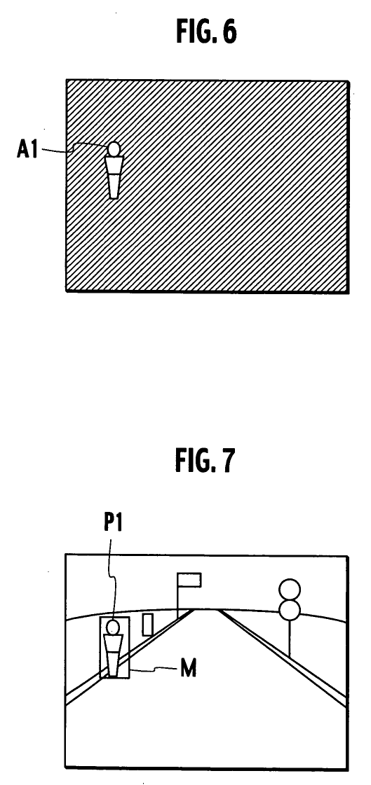

FIG. 6 is a diagrammatic view illustrating the pedestrian candidate region that remains after the pedestrian candidate regions determined to be structures by the structure exclusion processing have been excluded. The number N3 of bright regions remaining as pedestrian candidate regions after the structure exclusion processing is stored in the RAM 123. Thus, if the pixels were temporarily set to a gray level of 0 in the bright regions of the pedestrian candidate extraction image shown in FIG. 5 that have been determined to be structural regions, the image that remained would contain only the bright region corresponding to the pedestrian, as shown in FIG. 6.

In step S109, the CPU 111 reads the number N3 stored in the RAM 123 in step S108 and determines if there is a pedestrian region. If there is a pedestrian region, the CPU 111 proceeds to step S110. If not, the CPU 111 returns to step S101. In step S110, the image processing unit 112 executes processing to emphasize the brightness region determined to be a pedestrian. This processing involves reading the original image stored in the VRAM 121 in step S104 and adding a frame enclosing the brightness region or regions that have ultimately been determined to be pedestrian regions. The frame rectangular or any other reasonable shape and can be drawn with a dotted line, broken line, chain line, solid bold line or the like. It is also acceptable to emphasize the pedestrian region by substituting the maximum gray level 255 for all the pixels of the pedestrian region. The method of emphasizing the pedestrian region is not limited to those described here.

FIG. 7 shows the photographed image with the pedestrian region emphasized. In step S111, the image processing unit 112 outputs the original image with the frame added thereto to the HUD unit 104. FIG. 7 illustrates a case in which the image is projected onto the front windshield from the HUD unit 104. The frame M emphasizing the pedestrian P1 is displayed. In step S112 the CPU 111 issues an alarm sound signal to the speaker 105 to sound alarm. The alarm sound is issued for a prescribed amount of time and is then stopped automatically. After step S112, control returns to step S101 and the processing sequence is repeated.

FIG. 8 is a flowchart for explaining the processing used to extract the pedestrian candidate regions from among the extracted bright regions. This processing is executed by the CPU 111 and the image processing unit 112 (which is controlled by the CPU 111) in step S107 of the main flowchart shown in FIG. 3.

In step S201, the CPU 111 reads the number N1 of extracted region labels assigned to extracted bright regions from the RAM 123. In step S202, the CPU 111 initializes the label counter by setting n=1 and m=0, where n is a parameter for the number of bright regions (in this example the maximum value is N1=5) and m is a parameter for the number of bright regions extracted as pedestrian candidates during the processing of this flowchart.

In step S203, the image processing unit 112 sets a circumscribing rectangle with respect to the bright region to which the nth (initially n=1)an extracted region label has been assigned. In order to set the circumscribing rectangle, for example, the image processing unit 112 detects the pixel positions of the top and bottom edges and the pixel positions of the left and right edges of the bright region to which an extracted region label (initially n=1) has been assigned. As a result, on a coordinate system set on the entire original image, the bright region is enclosed in a rectangle composed of two horizontal line segments passing through the detected uppermost and bottommost pixel positions (coordinates) of the bright region and two vertical line segments passing through the detected leftmost and rightmost pixel positions (coordinates) of the bright region.

In step S204, the CPU 111 calculates the ratio of the vertical dimension to the horizontal dimension of the rectangle obtained in step S203. If the value of the ratio is within a prescribed range, e.g., if the vertical dimension divided by the horizontal dimension is between 4/1 and 4/3, then the CPU 111 proceeds to step S205.

The vertical to horizontal dimension ratio range of 4/1 to 4/3 is set using the shape of a standing person as a reference, but the range includes a large amount of leeway in the horizontal dimension in anticipation of such situations as a number of people standing close together, a person holding something in both hands, or a person holding a child. If the vertical to horizontal dimension ratio is outside the range 4/1 to 4/3, then the CPU proceeds to step S206.

If the vertical to horizontal dimension ratio is within the prescribed range, in step S205 the CPU 111 registers the region as a pedestrian candidate region and increases the label counter m by 1 (m=m+1). It also stores the fact that the pedestrian candidate region label m corresponds to the extracted region label n in the RAM 123 (MX(m)=n). From step S205, the CPU 111 proceeds to step S206.

In step S206, the CPU 111 determines if the label counter n has reached the maximum value N1. If not, the CPU 111 proceeds to step S207 and increases the label counter n by 1 (n=n+1). It then returns to step S203 and repeats steps S203 to S206 using n=2. These steps are repeated again and again, increasing n by 1 each time. When the label counter n reaches the value N1, the CPU 111 proceeds to step S208 where it stores the value of the label counter m as N2 in the RAM 123 (N2=m). Then, the CPU 111 proceeds to step S108 of the main flowchart shown in FIG. 3. N2 indicates the total number of pedestrian candidate regions. The processing executed by the series of steps S201 to S208 serves to extract pedestrian candidate regions from among the bright regions. This processing will now be described more concretely with respect to each of the bright regions A1 to A5 shown in FIG. 4B.

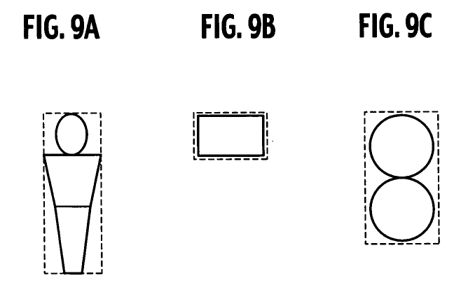

FIG. 9A is a diagrammatic view for explaining the method of determining if a bright region is a pedestrian candidate region based on the vertical to horizontal dimension ratio of the bright region. As shown in FIG. 9A, the region A1 has a vertical to horizontal dimension ratio of 3/1 and is thus a pedestrian candidate region. The region A2 shown in FIG. 4B is a vertically long sign having a vertical to horizontal dimension ratio in the range of 4/1 to 4/3 and is also a pedestrian candidate region. The region A3 shown in FIG. 4B is a horizontally long traffic sign and, since it has a vertical to horizontal dimension ratio of 1/1.5 as shown in FIG. 9B, it is excluded from the pedestrian candidate regions. The region A4 of FIG. 4B is a vertical series of round traffic signs and is a pedestrian candidate region because, as shown in FIG. 9C, it has a vertical to horizontal dimension ratio of 2/1. The region A5 shown in FIG. 4B is a region corresponding to the highly bright semi-elliptical portion directly in front of the vehicle where the near-infrared light from the floodlights 103 illuminates the road surface. Since it has a vertical to horizontal dimension ratio of smaller than 1, it is excluded from the pedestrian candidate regions. Thus, if only the bright regions determined to be pedestrian candidate regions in the manner explained here are shown, the image shown in FIG. 5 will be obtained.

Next, the bright regions determined to be pedestrian candidate regions are checked to see if they are structures. The structure exclusion processing used to exclude the regions that are structures from the regions that are pedestrian candidate regions will now be explained with reference to the flowchart shown in FIG. 10. This processing is executed by the CPU 111 and the image processing unit 112 (which is controlled by the CPU 111) in step S108 of the main flowchart shown in FIG. 3.

In step S301, the CPU 111 reads the number N2 of pedestrian candidate region labels from the RAM 123. In step S302, the CPU 111 initializes the label counter by setting m=1 and k=0, where m is a parameter for the number of pedestrian candidate regions and k is a parameter for the number of brightness regions remaining as pedestrian candidate regions during the processing of this flowchart. In step S303, the image processing unit 112 calculates the average gray level value E(m) of the brightness region corresponding to the pedestrian candidate region label m (i.e., the extracted region label MX(m)).

The average gray level value E(m) can be found using the following equation (1), where P(i) is the gray level of the i^{th} pixel of the brightness region corresponding to the pedestrian candidate region label m and 1m is the total number of pixels in the brightness region corresponding to the pedestrian candidate region label m.

$$E ( m ) = {\sum }_{i = 1}^{{I}_{m}} \frac{{P}_{m} ( i )}{{I}_{m}} K ( 1 ) \qquad ( 1 )$$

In step S304, the CPU 111 determines if the average gray level value E(m) calculated in step S303 exceeds a prescribed gray level value. It is appropriate for this prescribed gray level value to correspond to an extremely bright value. In the case of an 8-bit gray scale, the prescribed gray level value is set to, for example, 240 and regions having an average gray level value greater than this value are determined to be structures, such as traffic signs and other signs. The reason for this approach is that traffic signs and other signs are generally provided with a surface treatment that makes them good reflectors of light and, thus, such signs produce a strong reflected light when illuminated by the near-infrared light from the floodlights 103. Consequently, such signs are reproduced as image regions having a high gray level in the near-infrared image captured by the infrared camera 102.

However, since it is also possible for reflection from the clothing of a pedestrian to produce an image region having a high gray level, the CPU 111 does not determine that an object is a pedestrian merely because its average gray level value E(m) exceeds 240. Instead, it proceeds to step S305. Meanwhile, if the average gray level value E(m) is 240 or less, the CPU 111 proceeds to step S308. In step S305, the image processing unit 112 calculates the gray level dispersion value V(m) of the bright region corresponding to the pedestrian candidate region label m. The gray level dispersion value V(m) is found using the equation (2) shown below.

$$V ( m ) = {\sum }_{i = 1}^{{I}_{m}} \frac{{\{ {P}_{m} ( i ) - E ( m ) \}}^{2}}{{I}_{m}} K \qquad ( 2 )$$

In step S306, the CPU 111 determines if the gray level dispersion value V(m) calculated in step S305 is less than a prescribed gray level dispersion value. A value smaller than the prescribed dispersion value means that the variation in the gray level of the bright region corresponding to the pedestrian candidate region label m is small. The prescribed dispersion value is obtained experimentally and is set to such a value as 50, for example.

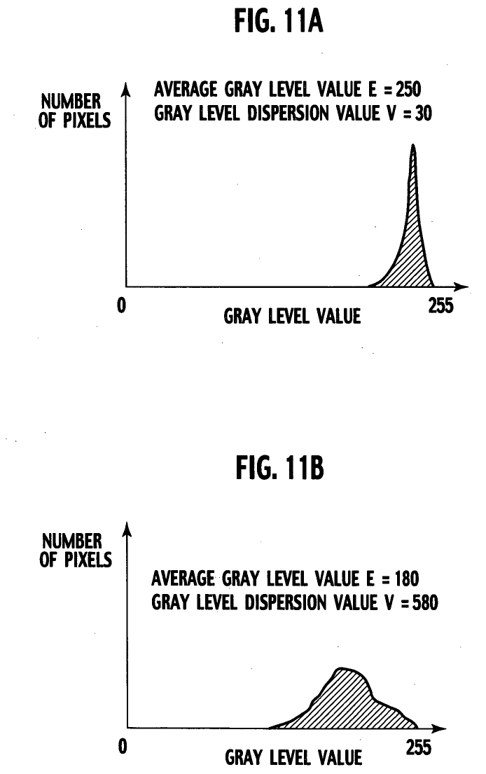

FIG. 11A is a gray level histogram illustrating a typical pixel gray level distribution in the case of a traffic sign or other road sign. The horizontal axis indicates the gray level and the vertical axis indicates the frequency. Then a structure has a flat planar portion, the near-infrared light shone thereon is reflected a nearly uniform manner such that, as shown in FIG. 11A, the gray level value is high and the dispersion is small. In this example, the average gray level value is 250 and the gray level dispersion value is 30.

Similarly, FIG. 11B is a gray level histogram illustrating a typical pixel gray level distribution in the case of a pedestrian. In many cases, the intensity of light reflected from the clothing of a pedestrian is weak and the gray level value is small. Additionally, the light is not reflected in a uniform manner because a person has a three-dimensional shape and because the reflective characteristics of clothing and skin are different. Thus, in the case of a person, the reflection is non-uniform overall and the dispersion value is large. In this example, the average gray level value is 180 and the gray level dispersion value is 580. The CPU 111 proceeds to step S307 if the dispersion value V(m) is less than 50 and to step S308 if the dispersion value V(m) is 50 or higher.

In step S307, the CPU 111 excludes the region corresponding to the pedestrian candidate region label m from the pedestrian candidates. In this embodiment, the procedure for excluding the region is to set the value of MX(m) to 0 and store the same in the RAM 123. After step S307, the CPU 111 proceeds to step S309. In cases where the CPU 111 proceeds to step S308 after steps S304 and S305, the CPU 111 registers the region corresponding to the pedestrian candidate region label m as a pedestrian region. In this embodiment, the procedure for registering the region is to store MX(m) in the RAM 123 as is and increase the value of the label counter k by 1 (k=k+1). After step S308, the CPU 111 proceeds to step S309.

In step S309, the CPU 111 determines if the label counter m has reached N2. If the label counter m has not reached N2, the CPU 111 proceeds to step S310 where it increases m by 1 (m=m+1) and returns to step S303, from which it repeats steps S303 to S309. If the label counter m has reached N2, the CPU 111 proceeds to step S311 where it sets the value of N3 to k and stores N3 in the RAM 123 as the total number of pedestrian regions registered. After step S311, since all of the pedestrian candidate regions have been subjected to structure exclusion processing, the CPU 111 returns to the main flowchart of FIG. 3 and proceeds to step S109.

The emphasis processing method used in step S110 of the main flowchart shown in FIG. 3 will now be described. During the emphasis processing, the CPU 111 reads the values of MX(m) stored in the RAM 123 for parameter m=1 to N2 and obtains the extraction region labels L (=MX(m)) whose values are greater than 0. The image processing unit 112 then accesses the original image stored in the VRAM 121 in step S104 and adds frames (as described previously) surrounding the bright regions corresponding to the extracted region labels L, i.e., the regions ultimately determined to be pedestrian regions.

In this embodiment, the infrared camera 102 constitutes the photographing means of the present invention, the head-up display unit 4 constitutes the display device, the vehicle surroundings monitoring control unit 1 constitutes the display control unit, step S105 of the flowchart constitutes the object extracting means of the present invention, step S107 (i.e., steps S201 to S208) constitutes the pedestrian candidate extracting means, and step S108 (i.e., steps S301 to S311) constitutes the structure determining means. Also, step S203 constitutes the rectangle setting means, step S204 constitutes the vertical to horizontal dimension calculating means, step S303 constitutes the average gray level calculating means, and step S305 constitutes the gray level dispersion calculating means.

As described heretofore, this embodiment extracts pedestrian candidate regions based on the vertical to horizontal dimension ratios of bright regions corresponding to extracted objects, calculates the average gray level value and gray level dispersion value of the pedestrian candidate regions, and determines that the pedestrian candidate regions are structures if the average gray level value is larger than a prescribed value and the gray level dispersion value is smaller than a prescribed value. This approach increases the degree of accuracy with which pedestrians are detected. As a result, even in a situation where multiple traffic signs and pedestrians are intermingled, the chances that the system will mistakenly indicate a traffic sign as a pedestrian to the driver can be reduced.

Since floodlights are used to illuminate objects in front of the vehicle with near-infrared light and reflected near-infrared light from the illuminated objects is photographed with an infrared camera to obtain an image from which the objects are extracted, objects located at farther distances can be photographed more clearly. As a result, the gray level distribution of the bright regions of the photographed image resulting from the light reflected from the objects is easier to ascertain.

Since template matching processing is not used and the vertical to horizontal dimension ratio and the gray level distribution (average gray level value and gray level dispersion value) are calculated, the image processing load of the vehicle surroundings monitoring device is light and the monitoring device can be realized with inexpensive components.

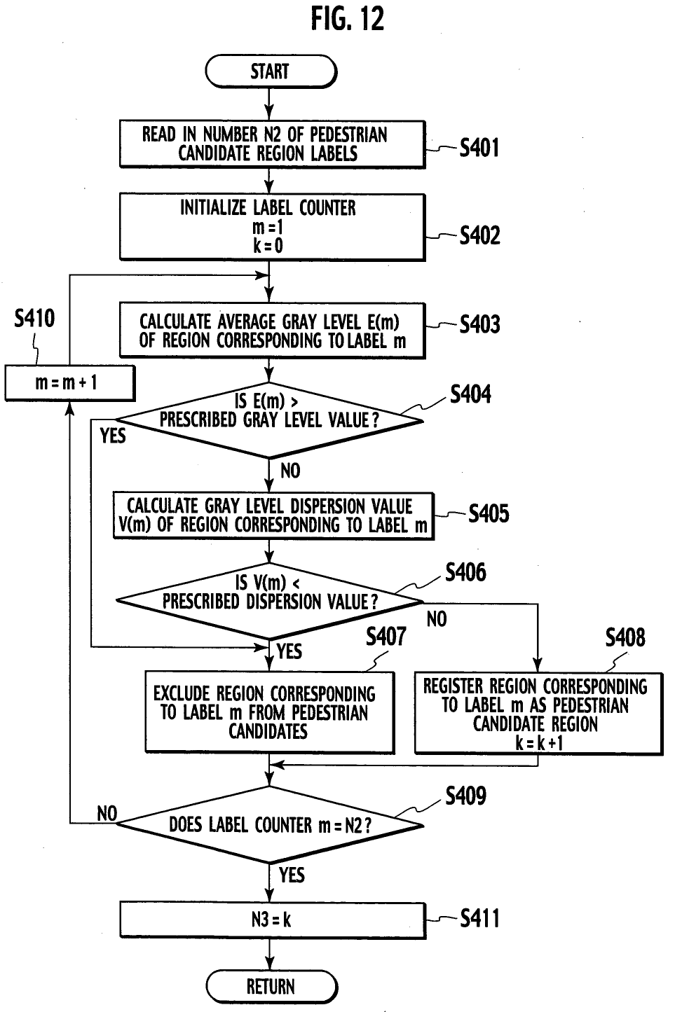

A variation of the embodiment will now be described. FIG. 12 is obtained by modifying a portion of the flowchart shown in FIG. 10, which shows the processing used to exclude structures from the extracted pedestrian candidate regions. More specifically, the processing details of the individual steps S401 to S411 are the same as those of the steps S301 to S311. The difference between the flowcharts lies in flow pattern among steps S404 to S409. The flowchart of FIG. 12 will now be described starting from step S404.

In step S404, the CPU 111 determines if the average gray level value E(m) calculated in step S403 exceeds the prescribed gray level value. If the average gray level value E(m) exceeds 240, the region is determined to be a structure and the CPU 111 proceeds to step S407. If the average gray level value E(m) is equal to or less than 240, the CPU 111 proceeds to step S405.

In step S405, the image processing unit 112 calculates the gray level dispersion value V(m) of the bright region corresponding to the pedestrian candidate region label m. In step S406, the CPU proceeds to step S407 if the gray level dispersion value V(m) calculated in step S405 is less than 50 and to step S408 if the same is 50 or higher.

In step S407, the CPU 111 excludes the region corresponding to the pedestrian candidate region label m from the pedestrian candidates. In this embodiment, the procedure for excluding the region is to set the value of MX(m) to 0 and store the same in the RAM 123. After step S407, the CPU 111 proceeds to step S409. In cases where the CPU 111 proceeds to step S408 after step S406, the CPU 111 registers the region corresponding to the pedestrian candidate region label m as a pedestrian region. In this embodiment, the procedure for registering the region is to store MX(m) in the RAM 123 as is and increase the value of the label counter k by 1 (k=k+1). After step S408, the CPU 111 proceeds to step S409.

In step S409, the CPU 111 determines if the label counter m has reached N2. If the label counter m has not reached N2, the CPU 111 proceeds to step S410 where it increases m by 1 (m=m+1) and returns to step S403, from which it repeats steps S403 to S409. If the label counter m has reached N2, the CPU 111 proceeds to step S411 where it sets the value of N3 to k and stores N3 in the RAM 123 as the total number of pedestrian regions registered. After step S411, since all of the pedestrian candidate regions have been subjected to structure exclusion processing, the CPU 111 returns to the main flowchart of FIG. 3 and proceeds to step S109.

With the previously described embodiment, even if the average gray level value of the pedestrian candidate region corresponding to the label m exceeds 240, the region is not determined to be a structure unless the dispersion value of the region is less than 50. Conversely, with the variation described heretofore, the region corresponding to the label m is determined to be a structure directly if the average gray level value thereof exceeds 240 and, even if the average gray level value of the region is less than 240, the region is not determined to be a pedestrian unless the dispersion value is 50 or larger.

Thus, the variation tends to recognize fewer objects as pedestrians than does the embodiment. Since the average gray level value and dispersion value required to make highly accurate determinations as to whether or not objects are pedestrians depends on the characteristics of the infrared camera and the floodlights used, it is also acceptable to configure the vehicle surroundings monitoring device such that the user can select between these two pedestrian determination control methods. Furthermore it is also acceptable to configure the vehicle surroundings monitoring device such that the user can change the pedestrian determination control method.

In both the embodiment and the variation, an alarm sound is issued in step S112 when a pedestrian region is detected based on the infrared camera image. It is also acceptable to configure the vehicle surroundings monitoring device to calculate the distance from the vehicle to the pedestrian in the forward direction based on the bottommost camera image coordinate (which corresponds to the pedestrian's feet) of the bright region ultimately determined to be a pedestrian region in the camera image and issue the alarm sound if the calculated distance is less than a prescribed distance.

Additionally, it is also acceptable to vary the prescribed distance depending on the vehicle speed such that the faster the vehicle speed is, the larger the value to which prescribed distance is set. This approach can reduce the occurrence of situations in which the alarm sound is emitted even though the distance from the vehicle to the pedestrian is sufficient for the driver to react independently.

Although both the embodiment and the variation use a HUD unit as the display device of the vehicle surrounds monitoring device, the invention is not limited to a HUD unit For example, a conventional liquid crystal display built into the instrument panel of the vehicle is also acceptable.

The embodiment and variation thereof described herein is configured to extract the images of objects having shapes close to that of a pedestrian as pedestrian candidate images and then determine if each pedestrian candidate image is a structure using a simple method based on the gray level. The pedestrian candidate images that remain (i.e., are not determined to be structures) can then be recognized as pedestrians. This image processing method enables an inexpensive vehicle surroundings monitoring device to be provided because the load imposed on the CPU is light and a stereo camera device is not required.

The entire contents of Japanese patent application P2003-390369 filed Nov. twentieth, 2003 is hereby incorporated by reference.

The invention may be embodied in other specific forms without departing from the spirit or essential characteristics thereof. The present embodiment is therefore to be considered in all respects as illustrative and not restrictive, the scope of the invention being indicated by the appended claims rather than by the foregoing description, and all changes which come within the meaning and range of equivalency of the claims are therefore intended to be embraced therein.

1. A vehicle surroundings monitoring device, comprising:
an object extracting unit configured to extract objects that emit infrared rays from a photographed infrared image;
a pedestrian candidate extracting unit configured to extract pedestrian candidates based on the shape of the images of objects extracted by the object extracting unit; and
a structure exclusion processing unit configured to exclude structures from the pedestrian candidates based on the gray levels of the images of the pedestrian candidates.

2. The vehicle surroundings monitoring device as claimed in claim 1, wherein
the pedestrian candidate extracting unit comprises:
a rectangle setting unit configured to set rectangular frames circumscribing the images of objects extracted by the object extracting unit;
a vertical to horizontal dimension ratio calculating unit configured to calculate the vertical to horizontal dimension ratios of the rectangular frames set by the rectangle setting unit; and
a pedestrian determining unit configured to determine that an object is a passenger candidate when the vertical to horizontal dimension ratio of the corresponding frame is within a prescribed range of numerical values.

3. The vehicle surroundings monitoring device as claimed in claim 1, wherein
the pedestrian determining unit determines that an object is a passenger candidate when the vertical to horizontal dimension ratio is in the range from 4:1 to 4:3.

4. The vehicle surroundings monitoring device as claimed in claim 1, wherein
the structure exclusion processing unit comprises:
an average gray level calculating unit configured to calculate the average value of the gray level distribution of an image of a pedestrian candidate;
a gray level dispersion calculating unit configured to calculate the dispersion value of the gray level distribution of an image of a pedestrian candidate; and
a structure determining unit configured to determine that the image of a pedestrian candidate is a structure and exclude the image from the pedestrian candidates when the average gray level value of the image of the pedestrian candidate is equal to or larger than a prescribed value or when the gray level dispersion value of the image of the pedestrian candidate is equal to or below a prescribed value.

5. The vehicle surroundings monitoring device as claimed in claim 1, wherein
the structure exclusion processing unit comprises:
an average gray level calculating unit configured to calculate the average value of the gray level distribution of an image of a pedestrian candidate;
a gray level dispersion calculating unit configured to calculate the dispersion value of the gray level distribution of an image of a pedestrian candidate; and
a structure determining unit configured to determine that the image of a pedestrian candidate is a structure when the average gray level value of the image of the pedestrian candidate is equal to or larger than a prescribed value and the gray level dispersion value of the image of the pedestrian candidate is equal to or below a prescribed value.

6. The vehicle surroundings monitoring device as claimed in claim 1, further comprising an image processing unit electrically coupled to an infrared camera, the image processing unit configured to obtain an infrared image from the infrared camera and store the infrared image; and
wherein the object extracting unit is configured to extract objects using an infrared image acquired by the mage processing unit.

7. The vehicle surroundings monitoring device as claimed in claim 6, further comprising a display device provided in front of the driver's seat of the vehicle and configured to display an infrared image photographed by the infrared camera; and
wherein the display control unit is configured to emphasize the images of the pedestrian candidates that have not been determined to be structures by the structure exclusion processing unit.

8. The vehicle surroundings monitoring device as claimed in claim 3, wherein
the display control unit is configured to emphasize the images of the pedestrian candidates that have not been determined to be structures by enclosing said images in frames drawn with a dotted line, broken line, chain line, or a solid bold line.

9. The vehicle surroundings monitoring device as claimed in claim 6, further comprising a vehicle speed sensor configured to detect the speed of the vehicle in which the vehicle speed surroundings monitoring device is installed; and
wherein the display control unit is configured to display the infrared image on the display device when the vehicle speed is equal to or above a prescribed value.

10. A vehicle surroundings monitoring device, comprising:
an object extracting means for extracting objects that emit infrared rays from a photographed infrared image;
a pedestrian candidate extracting means for extracting pedestrian candidates based on the shape of the images of objects extracted by the object extracting unit; and
a structure exclusion processing means for excluding structures from the pedestrian candidates based on the gray levels of the images of the pedestrian candidates.

11. A vehicle surroundings monitoring method, comprising:
emitting infrared rays from a vehicle;
receiving infrared rays reflected from objects existing in the vicinity of the vehicle and creating an infrared image;
extracting from the infrared image those objects that reflect a quantity of infrared rays equal to or exceeding a prescribed quantity;
extracting the images of pedestrian candidates based on the shapes of the images of the extracted objects;
determining if the pedestrian candidates are structures based on the gray levels of the images of the pedestrian candidates; and
determining that the pedestrian candidates that have not been determined to be structures are pedestrians.

12. The vehicle surroundings monitoring method as claimed in claim 11, wherein
the procedure of extracting the images of pedestrian candidates based on the shapes of the images of the extracted objects, comprises:
setting a rectangular frame circumscribing the images of objects extracted by the object extracting unit;
calculating the vertical to horizontal dimension ratios of the rectangular frames set by the rectangle setting unit; and
determining that the objects whose images are circumscribed by rectangular frames having vertical to horizontal dimension ratios within a prescribed range of numerical values are pedestrian candidates.

13. The vehicle surroundings monitoring method as claimed in claim 12, wherein
the vertical to horizontal dimension ratio is in the range from 4:1 to 4:3

14. The vehicle surroundings monitoring method as claimed in claim 11, wherein
the procedure of the determining if the pedestrian candidates are structures based on the gray levels of the images of the pedestrian candidates, comprises:
calculating the average value of the gray level distribution of an image of a pedestrian candidate;
calculating the dispersion value of the gray level distribution of an image of a pedestrian candidate; and
determining that the image of a pedestrian candidate is a structure and exclude the image from the pedestrian candidates when the average gray level value of the image of the pedestrian candidate is equal to or larger than a prescribed value or when the gray level dispersion value of the image of the pedestrian candidate is equal to or below a prescribed value.

15. The vehicle surroundings monitoring method as claimed in claim 11, wherein
the procedure of the determining if the pedestrian candidates are structures based on the gray levels of the images of the pedestrian candidates, comprises
calculating the average value of the gray level distribution of an image of a pedestrian candidate;
calculating the dispersion value of the gray level distribution of an image of a pedestrian candidate; and
determining that the image of a pedestrian candidate is a structure when the average gray level value of the image of the pedestrian candidate is equal to or larger than a prescribed value and the gray level dispersion value of the image of the pedestrian candidate is equal to or below a prescribed value.

16. The vehicle surroundings monitoring method as claimed in claim 11, further comprising:
emphasized displaying images of the pedestrian candidates that have not been determined to be structures.

17. The vehicle surroundings monitoring method as claimed in claim 16, wherein
the emphasized displaying is carried out by enclosing said images in frames drawn with a dotted line, broken line, chain line, or a solid bold line.

18. The vehicle surroundings monitoring device as claimed in claim 16, wherein
the emphasized displaying is carried out when the vehicle speed is equal to or above a prescribed value.
